(19) United States
(12) Patent Application Publication
(10) Pub. No.: US 2024/0428353 A1
(43) Pub. Date: Dec. 26, 2024

(54) Systems and Methods for Digital Real Estate Record Keeping

(71) Applicant: John D. Guderyon, Waldo, WI (US)

(72) Inventor: John D. Guderyon, Waldo, WI (US)

(21) Appl. No.: 18/749,883

(22) Filed: Jun. 21, 2024

Related U.S. Application Data
(60) Provisional application No. 63/509,966, filed on Jun. 23, 2023.
(60) Provisional application No. 63/633,359, filed on Apr. 12, 2024.

(51) Int. Cl. G06Q 50/16; G06Q 20/36

(52) U.S. Cl. CPC G06Q 50/16; G06Q 20/367

(57) ABSTRACT

Embodiments of methods for real estate record keeping via blockchain are disclosed. Generally, a property having any address may be associated with a non-fungible token (NFT) and a webpage with two-factor authentication. That webpage may be updated whenever any renovations (maintenance or upgrades) are performed on a property, acting as a digital record book for all events related to the property. This facilitates clear communication between all parties (homeowners/sellers, buyers, banks, insurance companies, etc.) to streamline data sharing and third-party verification.

### RELATED APPLICATIONS

This non-provisional application claims the benefit of Provisional U.S. Patent Application No. 63/509,966, filed Jun. 23, 2023 and entitled “Method for Digital Real Estate Record Keeping,” as well as Provisional U.S. Patent Application No. 63/633,359, filed Apr. 12, 2024 and entitled “Systems and Methods for Digital Real Estate Record Keeping,” both of which are incorporated herein in their entireties.

### BACKGROUND OF THE INVENTION

In selling a property, an owner has to work with not only the buyer, but also agents, banks and mortgage companies, insurers, title, escrow agents, home inspectors, and warranty providers. This many parties creates ample opportunities for critical information to fall through the cracks. Especially critical in many property transfers are information related to property improvements, which buyers need in order to conduct their diligence in inspecting the property. Further, this information is useful for other entities for a variety of reasons, including appraisal of property value, insurance validation & transparency and ongoing construction, maintenance, warranties, etc.

Traditional methods of protecting and passing critical information on to others may involve handwritten papers, invoices, and brochure binders that must be copied and physically taken to, mailed to, or emailed to other parties. Yet, these methods run the very real risk of losing this data, as handwritten notes become lost or unreadable and delivery methods may be unreliable. Thus, a more reliable way of storing, documenting, indexing, and transferring this information is desired.

In recent years, online information storage technology has exploded, with cloud storage and online servers offering nearly unlimited space for relatively cheap. It became easier than ever to store and access information if you knew how and where to find it. Even more recently, a new trend for owning and trading information and both tangible and intangible assets has arisen with the advent of non-fungible tokens (NFT's). An NFT is a unique digital asset that has its ownership represented on a blockchain network, which is an online ledger that is shared among nodes in a computer network.

Each NFT is unique, which in theory gives its owner better assurance of safety against unauthorized recreation, tampering, or destruction, since ownership is easy to verify by reviewing the blockchain ledger. NFTs may take the form of collectibles, digital art, video game items, domain names, contracts, event tickets, data, and many other forms. NFTs may also act as gateways to information stored online. Thus, improved methods of recording keeping and sharing utilizing blockchain capabilities are desired and disclosed.

### SUMMARY OF THE INVENTION

Embodiments of methods according to the present invention relate generally to digital record keeping for real estate properties. More specifically, the present invention relates to using non-fungible tokens (NFT's) to redirect to critical information regarding home improvements and maintenance to allow select access to that information at the accessor's convenience. Generally, a method for digital real estate record keeping comprising the steps of creating a first webpage accessible over the internet, establishing a digital asset associated with a first real estate property, the digital asset comprising the address of the first real estate property, and entering and storing information related the first real estate property on the first webpage.

According to an aspect of an embodiment of a method according to the present invention, the creating step temporally takes place after the digital asset establishing step.

According to another aspect of an embodiment of a method according to the present invention, the first real estate property comprises a building.

According to yet another aspect of an embodiment of a method according to the present invention, the first real estate property comprises a commercial building.

According to still another aspect of an embodiment of a method according to the present invention, wherein the first real estate property comprises a residential building.

According to a further aspect of an embodiment of a method according to the present invention, the method further comprises the step of transferring ownership of the digital asset.

According to a yet further aspect of an embodiment of a method according to the present invention, the transferring step comprises a sale of the digital asset from one party to another, the sale being recorded on a blockchain.

According to a yet further aspect of an embodiment of a method according to the present invention, the establishing step is completed by a custodian and the sale takes place between the custodian and the owner of the first real estate property.

According to a yet further aspect of an embodiment of a method according to the present invention, the sale of the digital asset is completed at the same time as the sale of the first real estate property.

According to a yet further aspect of an embodiment of a method according to the present invention, the digital asset comprises a non-fungible token (NFT).

According to a yet further aspect of an embodiment of a method according to the present invention, the NFT further comprises a machine-readable code that, when scanned, links to the first webpage.

According to a yet further aspect of an embodiment of a method according to the present invention, the method further comprises the step of scanning the machine-readable code to access the first webpage.

According to a yet further aspect of an embodiment of a method according to the present invention, the scanning step comes before the entering and storing information step.

According to a yet further aspect of an embodiment of a method according to the present invention, the machine-readable code is a quick-response (QR) code.

According to a yet further aspect of an embodiment of a method according to the present invention, the NFT further comprises an image of the first real estate property.

According to a yet further aspect of an embodiment of a method according to the present invention, the first webpage is stored on a server owned and operated by a custodian.

According to a yet further aspect of an embodiment of a method according to the present invention, the first webpage is hosted on a website owned and operated by the custodian.

According to a yet further aspect of an embodiment of a method according to the present invention, the first webpage comprises a security system and the method further comprises the step of passing through the security system before the entering and storing information on the first webpage step.

According to a yet further aspect of an embodiment of a method according to the present invention, the security system comprises creating a profile on the website comprising a username and password and the first webpage is only accessible after entering the username and password.

According to a yet further aspect of an embodiment of a method according to the present invention, the website hosts a plurality of other webpages in addition to the first webpage.

### BRIEF DESCRIPTION OF THE DRAWINGS

FIG. 1 is a flow chart of a method according to the present invention.

FIG. 2 is a diagram of a method according to the present invention relating an NFT to a webpage database.

FIG. 3 is a flow chart of a second embodiment of a method according to the present invention.

FIG. 4 is a diagram depicting the relative roles of the custodian and property owner/other webpage accessor according to the present invention.

FIG. 5 is a diagram of a system according to the present invention.

### DESCRIPTION OF THE PREFERRED EMBODIMENT

Although the disclosure hereof is detailed and exact to enable those skilled in the art to practice the invention, the physical embodiments herein disclosed merely exemplify the invention which may be embodied in other specific structures. While the preferred embodiment has been described, the details may be changed without departing from the invention.

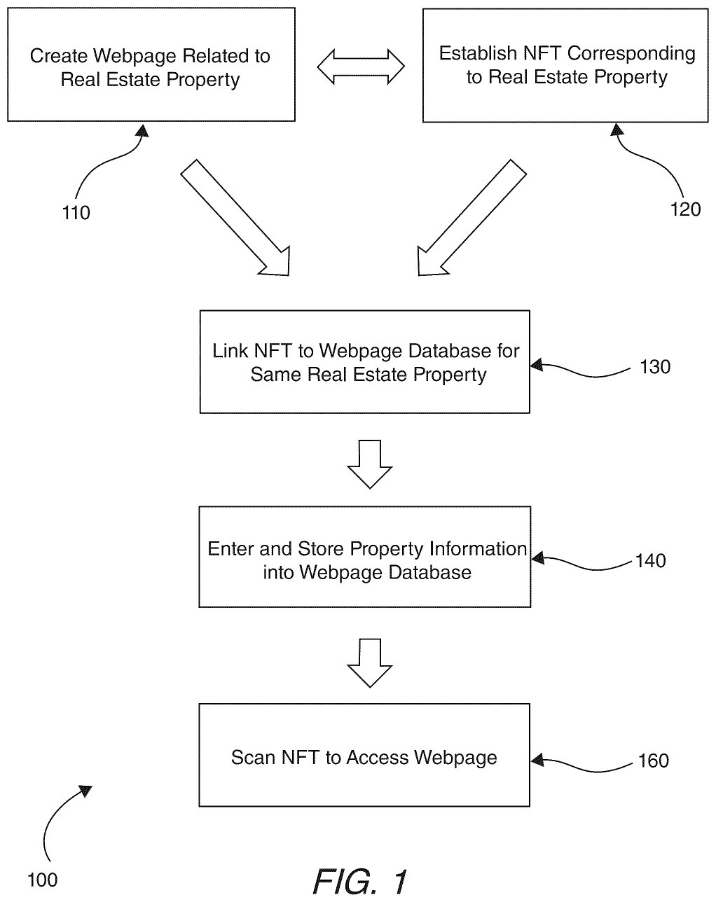

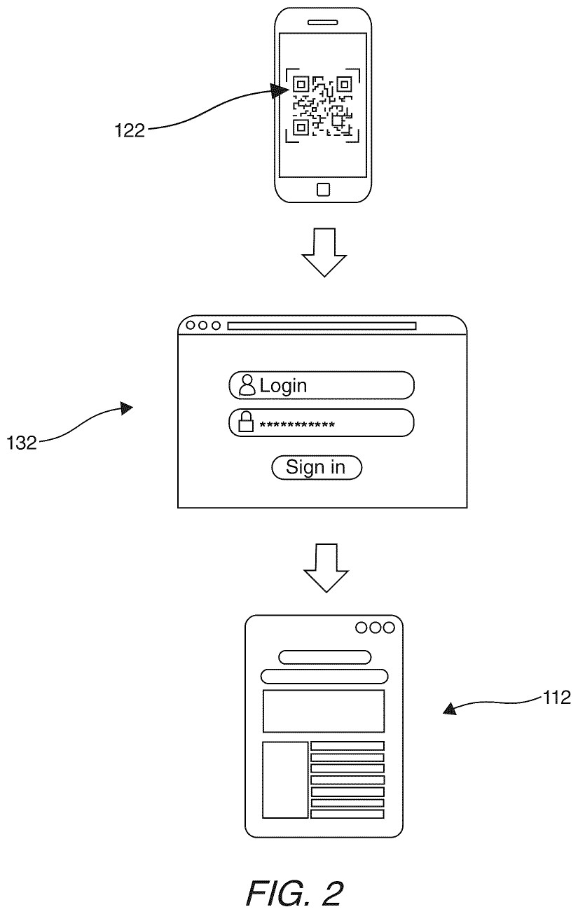

Turning now to Figures, embodiments of systems and methods for real estate record keeping via blockchain according to the present invention can be seen. As seen in FIGS. 1 and 2, a method 100 for digitally storing and maintaining real estate records may begin with a creation step 110. In the creation step 110, a database stored on a webpage 112 is created. This webpage 112 relates to a certain piece of real estate property, such as a house, commercial or office building, or land parcel. The webpage 112 is preferably created and hosted by a single custodian 142 (not pictured), such that many webpages 112, each relating to a different piece of real estate property, may exist on one website owned and operated by the custodian 142 and the webpages 112 are collectively stored on the same server(s). Each webpage 112 may have a standard default layout created by the custodian 142, but is preferably substantially empty of information and/or content immediately upon completion of the creation step 110. Later in the process, the real estate property owner 144 and/or a trusted third-party, such as a contractor or builder, may edit this webpage database 112 to upload information regarding the real estate property and improvements thereto. When webpage 112 is created, it is automatically locked behind a security access point (e.g. username and password login, biometrics login, two-factor authentication, etc.) These login credentials may be set by the custodian 142 initially, but are preferably customizable at a later point, allowing the owner of the NFT 122 linked to the real estate property to set up their own personal login credentials.

In a digital asset establishment step 120, the real estate property is associated with a digital asset, preferably a Non-Fungible Token (NFT) 122, to connect the property and its unique characteristics to the digital asset on a blockchain network. To accomplish this task, a unique NFT 122 is minted for each real estate property in the network. The NFT's 122 may be minted one by one, as the real estate property owners and/or contractors working on that real estate property decide to join the custodian's 142 network, or NFTs 122 may be minted en masse to correspond to addresses across the country. NFT's 122 are relatively cheap to mint and may be produced through NFT marketplaces such as SuperRare®, Foundation®, OpenSea®, or Crossmint®. Once created, an NFT is stored on a blockchain, which is a digital ledger that records information regarding the NFT, such as all transactions that it has been involved with, all owners through the current owner, etc. This promotes secure and transparent transactions between an NFT owner and potential buyer. Further, once an NFT is minted, it is stored on the blockchain forever and cannot be changed or deleted. Other forms of digital assets are also contemplated in connection with the present invention, such as convertible virtual currency and cryptocurrency.

To create an NFT 122, such as one that may be utilized in the method 100, a user creates and uploads a digital file to one of these NFT marketplaces, where it may be traded using cryptocurrency or other forms of currency connected to the creator's account. The digital files that make up NFTs may range from pictures to artwork to fully digitally-created works. However, the NFT's 122 used in conjunction with method 100 are preferably created from customized generated machine-readable codes, such as a bar code or, most preferably, a quick response (QR) code. Each NFT 122 preferably consists of one code linking to a certain webpage 112 that acts as a database on the internet that was already affiliated with the same piece of real estate property as the NFT 122 was in step 110. Thus, the QR-code NFT 122 is associated with the real estate property through its ability to link to the webpage 112 listing information regarding that same piece of real estate property.

Each generated QR-code may be either a static QR-code, which cannot be changed once created, or a dynamic QR-code, which may be edited after creation. However, since the QR-code will be minted into an NFT 122, and thus unchangeable after minting anyway, a static QR-code is preferable. The NFT 122 also preferably incorporates the actual address of the real estate property in some may, most preferably by including the address in written form on the NFT 122 image, such as above or below the QR-code.

In alternative embodiments of an NFT 122 according to the present invention, the NFT 122 may include and/or incorporate an image linking the NFT 122 to the actual real estate property in addition to or instead of a machine-readable code. For example, NFT 122 could include an image of the real estate property and/or structures located on the property, such as a house or office building. Additionally or alternatively, the NFT 122 preferably includes and/or incorporates the actual address of the real estate property, whether on its own or in conjunction with an image representing the real estate property as described above. The inclusion of the real estate property address connects the NFT 122 to the actual real estate property, such that it is apparent to anyone which NFT 122 goes with which property. This prevents confusion at later times for both the custodian 142, who is in charge of hosting all NFTs 122 according to the present invention, and for the property/NFT owner 144, who may own and/or maintain numerous properties and thus have numerous NFTs 122 to keep track of. In some embodiments of the NFT 122 according to the present invention, the NFT 122 may only include an image of the address of the real estate property itself, written out. Finally, some embodiments of the NFT 122 may consist of some other image, video, etc., wherein the NFT 122 includes in its description and/or labelling the address of the real estate property it is linked to. In some way, every embodiment of the NFT 122 preferably comprises the real estate property address to avoid confusion.

It should be understood that steps 110 and 120 are relatively interchangeable in terms of timing, as can be seen in FIG. 1. That is, step 120, the creation of the NFT 122 and association with a property, may take place before step 110, the creation of the webpage 112 to store information about that same property. At a later point then, the custodian 142 may return and associate the NFT 122 from step 120 with the webpage database 112 from step 110.

In step 130 of the method 100, information regarding the real estate property is uploaded to the webpage database 112 related to the specific piece of real estate property. To access this webpage 112, an information uploader may simply scan the QR-code NFT 122, using a mobile phone for example or another form of code scanner that may connect to the internet. Alternatively, the webpage 112 may be accessed by any computer connected to the internet (e.g. smartphone browser, desktop computer, etc.) The webpage 112 is preferably secured using at least a username and password system, where anyone attempting to access the webpage 112 must input a username and password already associated with the webpage 112 in the custodian 142's system. These usernames and passwords are preferably set up through the custodian 142's website and require the custodian 142's approval before access to the real estate property's webpage 112 is granted. As discussed above, the username and password are preferably customizable by the digital asset 122 owner, or other webpage accessor 146, at a later point or may be customized upon creation by the custodian 142.

Further, an added layer of protection may involve a system of two-factor authentication 132. Two-factor authentication systems require users to provide two different authentication factors to verify themselves before being granted access. In the present method 100, a two-factor authentication system 132 may include the username and password factor explained above and may also include a special factor that must be entered, such as a PIN number, a location factor, a time factor, a number factor that changes after a specific set amount of time, or something similar. Some applications have been developed to assist in two-factor authentication, which allow users to link accounts and provide a certain code that may be used only for a small amount of time to log into their systems. However security is accomplished, it is most preferable that the webpage 112 have more than one security factor to protect information related to the real estate property.

Once an information uploader has adequately passed the security measures of the webpage 112, such as two-factor authentication 132, they may begin to enter information related to the real estate property in method 100 step 140, as diagramed in FIG. 2. The information uploader is most likely to be the custodian 142, but they may also be the real estate property owner, a builder/contractor/repair firm, or anyone else that has been trusted to pass the security measures. Information that is preferably uploaded to the real estate property webpage 112 includes information regarding any building (including blueprints, specifications, dates, builders, etc.) and information regarding the land and/or structures located on the property (including previous owners, uses, buildings, remarkable events, etc.).

Most preferably, the webpage 112 may be used to log information regarding property maintenance, repair, and improvement. For example, such information may include the real estate property address, the type of building(s) or structure(s) located on the property, the date that the NFT 122 was minted, the owner 144 of the real estate property, the owner of the NFT 122, the property square footage, the property lot size, the name of the contractor(s) working on a project, the start date of that project, the end date (or projected end date) of that project, a description of that project, projected or actual costs of the project (including parts breakdown and labor), parts lists (with parts identifiers, maker, color, etc.), and project plans. Other information not included in the above list may also be uploaded to the webpage 112 at the uploader's discretion. Once the webpage 112 has been created and NFT 122 has been minted, the owner 144 of the real estate property is notified that their account is ready for use.

Method 100 optionally concludes in scanning step 160 by the machine-readable NFT 122 to access the webpage 112 containing information regarding the real estate property. This scanning step may be completed by any party, including the property owner 144, custodian 142, or a third-party webpage accessor 146, such as an insurance company, contractor, real estate broker, and/or potential buyer. Scanning the machine-readable code NFT 122 to access the property webpage may be important in situations where access to verified and easy to read information regarding the property is important, such as insurance evaluations and home sales. Such quick access helps these processes move more efficiently and can save significant time and cost for both the property owner 144 and third-party in attempting to track down and verify such information. Further, the information provides transparency to third-parties, who may be comforted in the knowledge that such information is verified and covers the (at least recent) repair and upgrade history of the property completely.

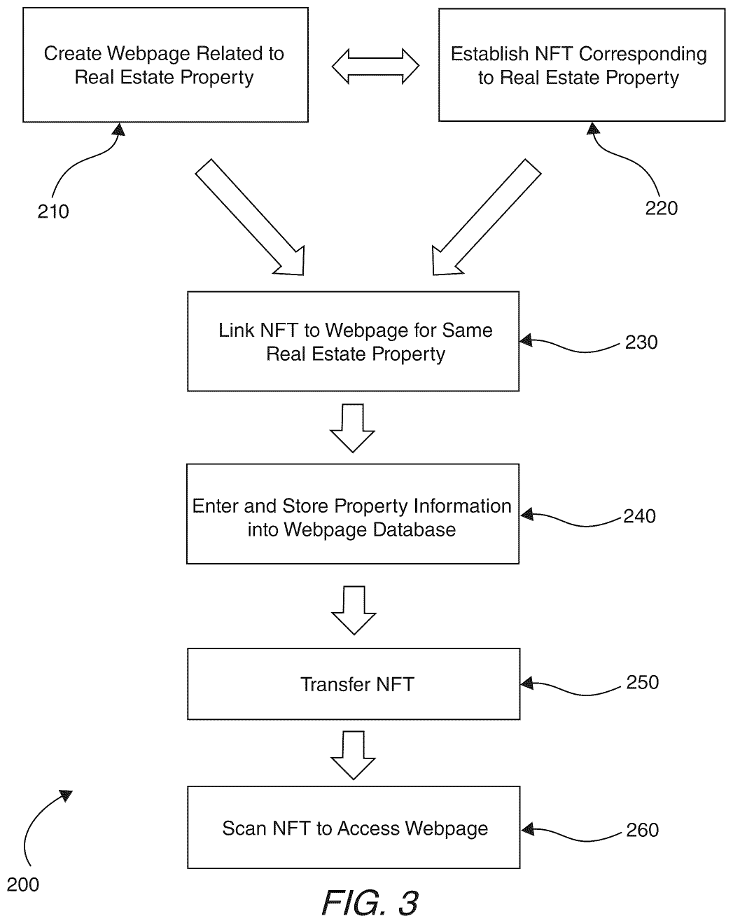

As seen more clearly in FIG. 3, a second embodiment method 200 according to the present invention may include an optional transferring step 250. Ownership of the NFT 122 may optionally be transferred from the custodian 142 to the real estate property owner 144. This embodiment of method 200 includes all of the steps of method 100, such that like numbers indicate like steps between FIGS. 1 and 3, with the addition of the transfer step 250. Transfer may be completed via sale of the NFT 122 on the blockchain from the custodian 142 to the real estate property owner 144, giving a clear chain of ownership from the originator to the current owner. Transfer of the NFT 122 may be advantageous to the property owner, as it adds a further asset to the property that may be included in any sale of the property down the line. Such sale would include terms regarding transfer of the NFT 122 as well on the blockchain. While transfer (e.g. sale) of the NFT 122 is not strictly necessary, it is preferable, as a clear chain of ownership of the NFT 122 can add transparency to potential buyers and/or insurers of the property regarding past ownership and work done on the property. Thus, the property owner 144 is incentivized to purchase the NFT 122 from the custodian 142, even if this transfer is not strictly required.

If a transfer from the custodian 142 to the property owner 144 is to be completed, transfer is preferably completed as soon as possible (i.e. as soon as all currently available/pertinent information regarding the real estate property has been uploaded to the webpage 112), as an earlier transfer allows the property owner 144 greater flexibility in including the NFT 122 in any deals regarding the property. Specifically, the property owner 144 may include the NFT 122 as an asset in any deal going forward (or, of course, transfer the NFT 122 however else they see fit).

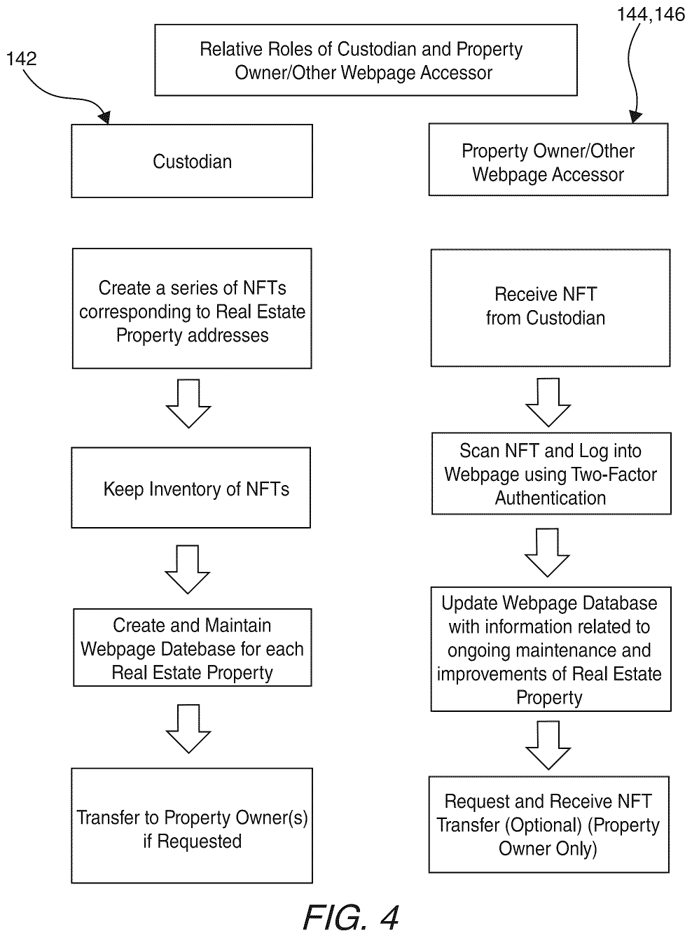

It should also be noted that transfer step 250 does not change the role of the custodian 142 in methods 100 and 200 according to the present invention. As seen in FIG. 4, in both methods 100 and 200, the custodian 142 remains the party in possession of the property's linked webpage 112, containing all the information regarding that property stored on the custodian 142's servers. Transfer step 250 is simply an asset transfer of the scannable link code NFT 122 to access the webpage 112, while the webpage 112 remains hosted on servers owned and/or controlled by the custodian 142. The custodian 142 may therefore keep the information protected and secure, even if many successive transfers of the NFT 122 have taken place.

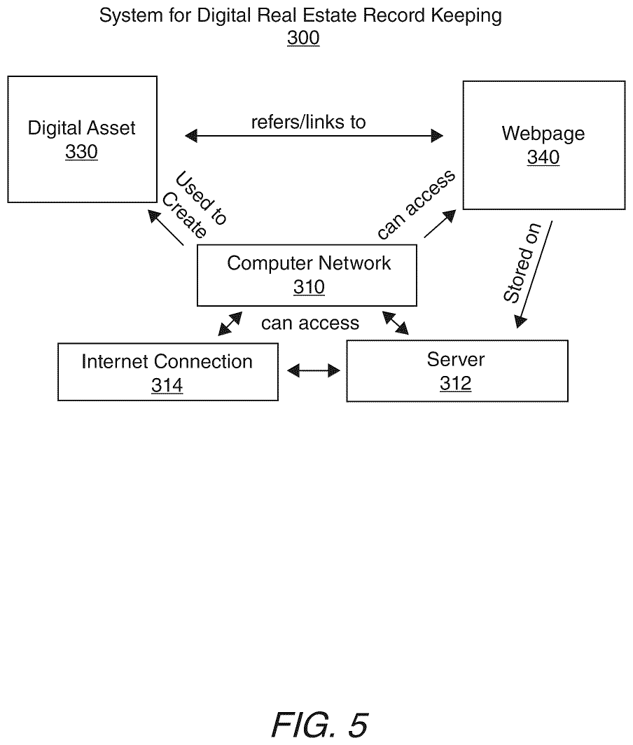

As seen in FIG. 5, a system 300 that can complete the methods 100, 200 described above generally comprises a computer network 310 in communication with a server 312 and an internet connection 314. Using the computer network 310, the custodian 142 can access a digital asset creation and/or minting marketplace 320 (as SuperRare®, Foundation®, OpenSea®, or Crossmint®) where the custodian 142 can create and/or mint a digital asset 330, such as NFT 122, to correspond to a specific real estate property. As explained above, such digital asset 330 may include a scannable code (e.g. QR-code) linking to a webpage 340 created and/or run by the custodian 142 and hosted on server 312.

Alternatively or additionally, the digital asset 330 may preferably include the address of the real estate property in written form and/or a picture of the real estate property and/or any structures located on that property. Preferably, the webpage 340 is substantially as described for the website 112 above in methods 100 and 200. For instance, the website 340 serves the same archival function as described for the webpage 112 above, where the owner the real estate property 144, the custodian 142, and/or any other trusted third party 146 may update the webpage 340 to include details regarding the real estate property and/or projects to be done, currently ongoing, or completed on the real estate property. The webpage 340 is also preferably protected by two-factor authentication techniques, as described above.

The foregoing is considered as illustrative only of the principles of the invention. Furthermore, because numerous modifications and changes will readily occur to those skilled in the art, it is not desired to limit the invention to the exact construction and operation shown and described. While the preferred embodiment has been described, the details may be changed without departing from the invention, which is defined by the claims.

I claim:

1. A method for digital real estate record keeping comprising the steps of:
creating a first webpage accessible over the internet;
establishing a digital asset associated with a first real estate property, the digital asset comprising the address of the first real estate property; and
entering and storing information related the first real estate property on the first webpage.

2. The method of claim 1, wherein the creating step temporally takes place after the digital asset establishing step.

3. The method of claim 1, wherein the first real estate property comprises a building.

4. The method of claim 3, wherein the first real estate property comprises a commercial building.

5. The method of claim 3, wherein the first real estate property comprises a residential building.

6. The method of claim 1, wherein the method further comprises the step of transferring ownership of the digital asset.

7. The method of claim 6, wherein the transferring step comprises a sale of the digital asset from one party to another, the sale being recorded on a blockchain.

8. The method of claim 7, wherein the establishing step is completed by a custodian and the sale takes place between the custodian and the owner of the first real estate property.

9. The method of claim 7, wherein the sale of the digital asset is completed at the same time as the sale of the first real estate property.

10. The method of claim 1, wherein the digital asset comprises a non-fungible token (NFT).

11. The method of claim 10, wherein the NFT further comprises a machine-readable code that, when scanned, links to the first webpage.

12. The method of claim 11, the method further comprising the step of scanning the machine-readable code to access the first webpage.

13. The method of claim 12, wherein the scanning step comes before the entering and storing information step.

14. The method of claim 11, wherein the machine-readable code is a quick-response (QR) code.

15. The method of claim 10, wherein the NFT further comprises an image of the first real estate property.

16. The method of claim 1, wherein the first webpage is stored on a server owned and operated by a custodian.

17. The method of claim 16, wherein the first webpage is hosted on a website owned and operated by the custodian.

18. The method of claim 17, wherein the first webpage comprises a security system and the method further comprises the step of passing through the security system before the entering and storing information on the first webpage step.

19. The method of claim 18, wherein the security system comprises creating a profile on the website comprising a username and password and the first webpage is only accessible after entering the username and password.

20. The method of claim 17, wherein the website hosts a plurality of other webpages in addition to the first webpage.
